(19) United States
(12) Patent Application Publication
(10) Pub. No.: US 2026/0319209 A1
(43) Pub. Date: Oct. 15, 2026

(54) FIBER OPTIC ALIGNMENT DEVICE

(71) Applicant: Gloriole Electroptic Technology Corp., Kaohsiung City (TW)

(72) Inventors: Yen-Chang LEE, Kaohsiung City (TW); Xian-Ru HU, Kaohsiung City (TW); Jim LIN, Kaohsiung City (TW)

(21) Appl. No.: 19/392,885

(22) Filed: Nov. 18, 2025

(30) Foreign Application Priority Data
Apr. 15, 2025 (TW) 114203710

(51) Int. Cl. G02B 6/44; G02B 6/36; G02B 6/38; G02B 6/42

(52) U.S. Cl. CPC G02B 6/448; G02B 6/3616; G02B 6/3803; G02B 6/4231; G02B 6/4446

(57) ABSTRACT

A fiber optic alignment device adapted for positioning a plurality of fiber optic wires includes two guide pins, a limiting member that is fixedly disposed on the guide pins and that is formed with a wire passing slit extending therethrough, and two combing members. Each of the combing members includes a base that is slidably disposed on the guide pins, and a pressing part that is disposed on the base and that is movable relative to the base. A height of the wire passing slit is adapted to match a diameter of each of the plurality of fiber optic wires. The base is formed with a plurality of positioning grooves that are adapted to receive the plurality of fiber optic wires. The pressing part is operable to move toward the base and to engage with the plurality of fiber optic wires received in the plurality of positioning grooves.

### CROSS-REFERENCE TO RELATED APPLICATION

This application claims priority to Taiwanese Utility Model Patent Application No. 114203710, filed on Apr. 15, 2025.

### FIELD

The disclosure relates to a wire alignment device, and more particularly to a fiber optic alignment device that ensures proper alignment of fiber optic wires during a bonding process.

### BACKGROUND

A conventional fiber optic ribbon cable is composed of a plurality of fiber optic wires that are arranged side-by-side in a specific order and glued together by their sides, thereby forming a ribbon-like structure. FIG. 1 illustrates a standard, conventional fiber optic ribbon cable 11 composed of a plurality of fiber optic wires 111, each of which has an outer diameter of 250 micron (μm). Since the fiber optic wires 111 are bonded by their sides, a distance between the central axes of any two adjacent fiber optic wires 111 is exactly 250 micron. FIG. 2 illustrates a more advanced and competitive generation of fiber optic wires 121 that ensues attributed to the rapid development of modern technologies, where each of the fiber optic wires 121 has a reduced outer diameter of 200 micron. However, in order to adapt a fiber optic cable 12 composed of the 200-micron fiber optic wires 121 to accommodate current standards, a distance between the central axes of any two adjacent fiber optic wires 121 is required to remain as 250 micron even though the outer diameter of each fiber optic wire 121 is reduced to 200 micron. In this case, each adjacent pair of the fiber optic wires 121 is required to keep a small distance therebetween without making contact. Since the fiber optic wires 121 are extremely thin and delicate, precise alignment and bonding of such fiber optic wires 121 becomes a major challenge for current technologies.

Referring to FIGS. 2 and 3, a conventional wire alignment device 2 used for forming the aforementioned fiber optic cable 12 includes a main board 21 that is formed with a wire receiving space 211, and a positioning member 22 that is connected to a front portion of the main board 21. The positioning member 22 is inverted U-shaped and cooperates with the main board 21 to define a connecting hole 212 that is spatially connected to the wire receiving space 211. The connecting hole 212 has a height that approximately matches the outer diameter of each of the fiber optic wires 121. The wire receiving space 211 has an abutment segment 213 that is disposed proximate to the positioning member 22, and an adhesion segment 214 that is connected to the abutment segment 213. Specifically, the main board 21 has a top surface that is formed with a plurality of track grooves 215 cooperatively defining the adhesion segment 214 and being spaced apart from each other.

During use of the conventional wire alignment device 2, the fiber optic wires 121 are inserted in a specific order though the connecting hole 212 and into the abutment segment 213. While in the abutment segment 213, the fiber optic wires 121 abut against each other for inspection to ensure they are arranged correctly. Later, the fiber optic wires 121 are pushed into the adhesion segment 214 with each of the fiber optic wires 121 being pushed into a respective one of the track grooves 215. The fiber optic wires 121 are then separated from each other since the track grooves 215 are spaced apart from each other. At this point, the fiber optic wires 121 may be bonded together (e.g., with an adhesive) to form into a single fiber optic cable 12.

However, since the wire alignment device 2 can only limit positions of the fiber optic wires 121 via the connecting hole 212 of the positioning member 22, once the fiber optic wires 121 pass through the connecting hole 212, they are susceptible to bending caused by excessive or unexpected forces, which may further lead to issues of deviation or misalignment and affect the manufacturing yield rate of the fiber optic cable 12. In addition, since a bonding operation is performed in the adhesion segment 214, maintenance and cleaning are required after each operation to remove residual adhesives from the main board 21, which may lead to fast wear and tear of the main board 21.

### SUMMARY

Therefore, an object of the disclosure is to provide a fiber optic alignment device used for positioning a plurality of fiber optic wires for bonding so as to form a ribbon fiber optic cable.

According to the disclosure, a fiber optic alignment device is adapted for positioning a plurality of fiber optic wires. The fiber optic alignment device includes two guide pins, a limiting member and two combing members.

The two guide pins extend in a wire routing direction and are spaced apart from each other in a horizontal direction perpendicular to the wire routing direction. The limiting member is fixedly disposed on the two guide pins and is formed with a wire passing slit that extends therethrough in the wire routing direction. A height of the wire passing slit in a vertical direction which is perpendicular to the wire routing direction and the horizontal directional is adapted to match a diameter of each of the plurality of fiber optic wires such that the wire passing slit is adapted to receive the plurality of fiber optic wires that are arranged side-by-side in the horizontal direction. Each of the two combing members includes a base that is slidably disposed on the two guide pins, and a pressing part that is disposed on the base and that is movable relative to the base. The base is formed with a plurality of positioning grooves that are arranged at intervals in the horizontal direction and that are adapted to receive the plurality of fiber optic wires. The pressing part is operable to move toward the base and to engage with the plurality of fiber optic wires received in the plurality of positioning grooves.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view, illustrating a conventional fiber optic cable composed of a plurality of 250-micron fiber optic wires.

FIG. 2 is a schematic view, illustrating a conventional fiber optic cable composed of a plurality of 200-micron fiber optic wires.

FIG. 3 is a top view of a conventional wire alignment device.

FIG. 4 is an exploded perspective view of an embodiment of a fiber optic alignment device according to the disclosure.

FIG. 5 is a fragmentary perspective view of the embodiment.

FIG. 6 is a sectional front view of the embodiment.

FIG. 7 is another fragmentary perspective view of the embodiment.

FIG. 8 is a perspective view of a combing member of the embodiment, illustrating an open state of the combing member.

FIG. 9 is an assembled perspective view of the embodiment.

FIG. 10 is another perspective view of the combing member, illustrating a closed state of the combing member.

FIG. 11 is a fragmentary top view of the embodiment in use with a plurality of fiber optic wires.

FIG. 12 is a schematic view, illustrating the open and closed states of the combing member in a variation of the embodiment.

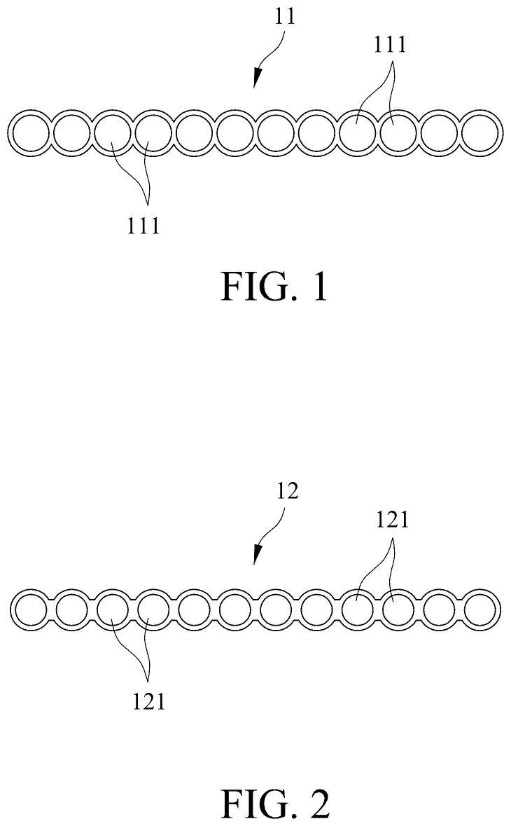

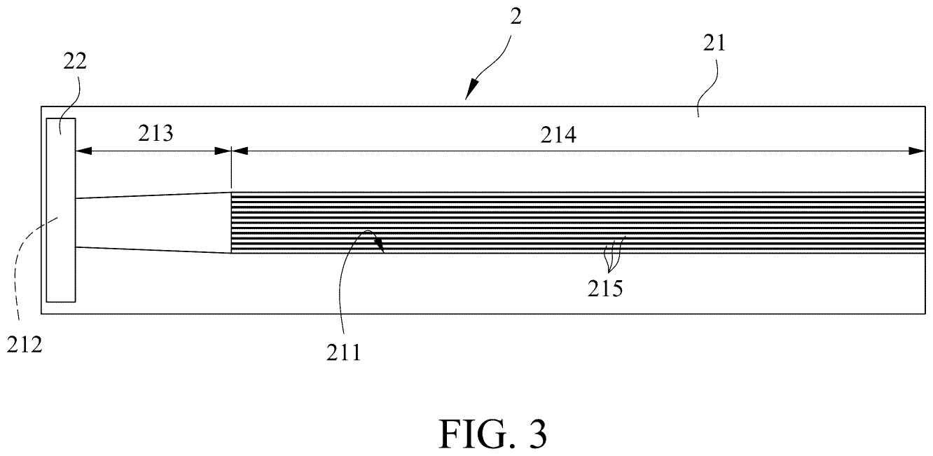

### DETAILED DESCRIPTION

Before the disclosure is described in greater detail, it should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

The relevant technical content, features, and functions of the present invention will be clearly presented in the following detailed description of the embodiments with reference to the accompanying drawings. It should be noted that the drawings of the present invention merely illustrate the relative structures and/or positions of the components and are not related to the actual dimensions of the components.

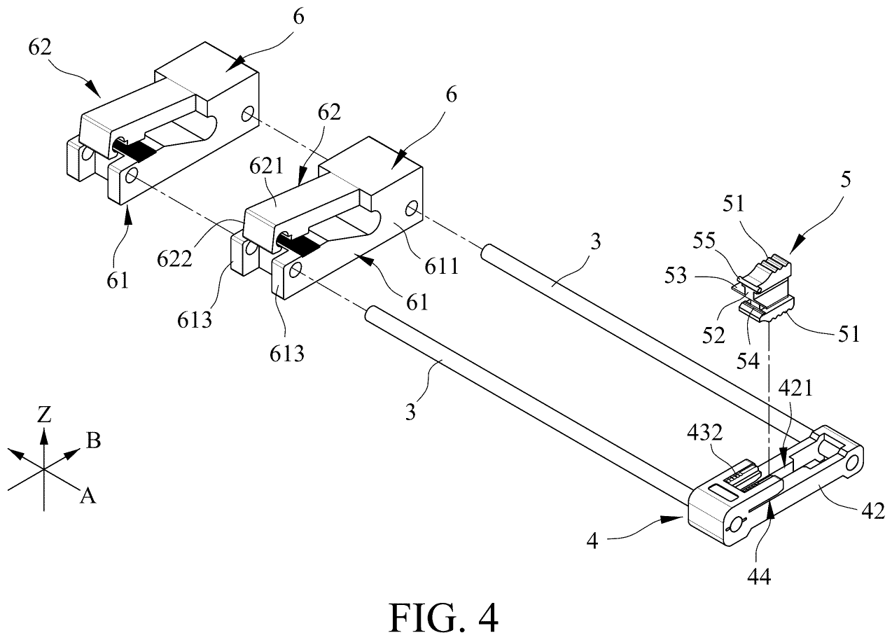

Referring to FIG. 4, an embodiment of a fiber optic alignment device according to the disclosure is used for positioning a plurality of fiber optic wires (C). The embodiment includes two guide pins 3 that extend in a wire routing direction (A) and that are spaced apart from each other in a horizontal direction (B) perpendicular to the wire routing direction (A), a limiting member 4 that is fixedly disposed on front end portions of the two guide pins 3, a positioning slider 5 that is disposed on the limiting member 4 and that is slidable in the horizontal direction (B) relative to the limiting member 4, and two combing members 6 that are disposed on the two guide pins 3 and that are slidable in the wire routing direction (A) relative to the guide pins 3. The limiting member 4 and the combing members 6 are arranged in order in the wire routing direction (A).

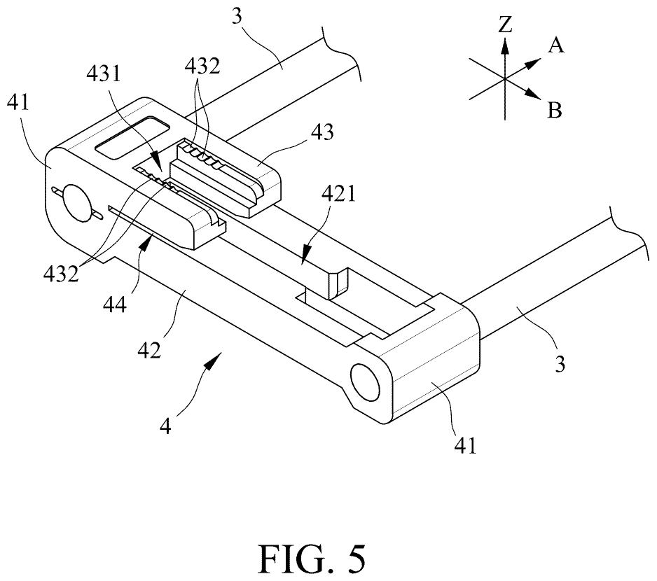

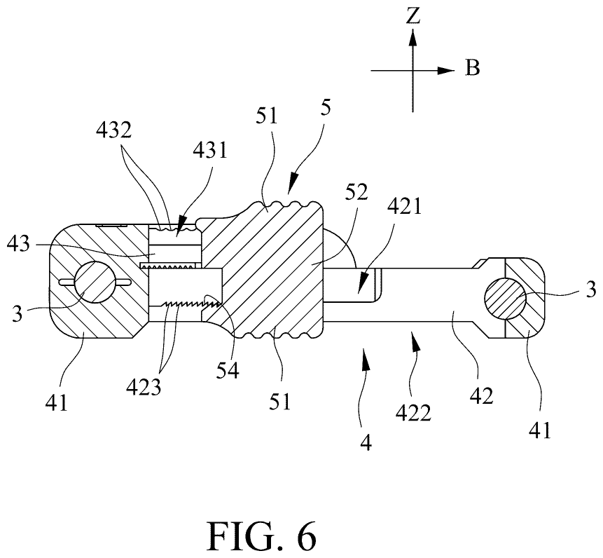

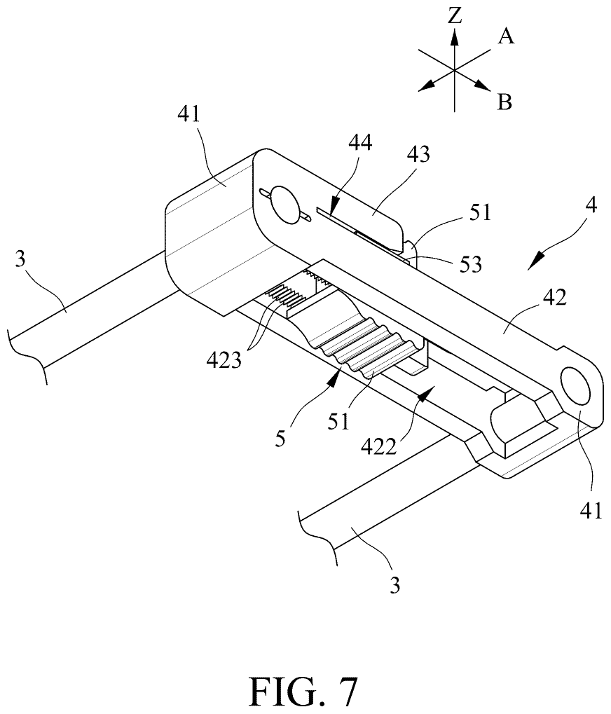

Referring to FIGS. 5, 6 and 7, the limiting member 4 includes two installing portions 41 that are sleeved respectively on the two guide pins 3, a bottom frame portion 42 that is connected between the two installing portions 41 in the horizontal direction (B), and a limiting arm portion 43 that extends from one of the two installing portions 41 toward another one of the installing portions 41. The limiting member 4 is formed with a wire passing slit 44 that extends therethrough in the wire routing direction (A), that is defined cooperatively by the bottom frame portion 42 and the limiting arm portion 43, and that has an open end disposed at one of opposite sides thereof in the horizontal direction (B). A height of the wire passing slit 44 measured in a vertical direction (Z) perpendicular to the wire routing direction (A) and the horizontal directional (B) is predetermined to match a diameter of each of the fiber optic wires (C) for receiving the fiber optic wires (C) that are arranged side-by-side in the horizontal direction (B).

The bottom frame portion 42 of the limiting member 4 is formed with a slide slot 421 that is elongated in the horizontal direction (B) and that is disposed under and in spatial communication with the wire passing slit 44, and a bottom slot 422 that is disposed under and in spatial communication with the slide slot 421. A width of the bottom slot 422 measured in the wire routing direction (A) is greater than a width of the slide slot 421 measured in the wire routing direction (A). The slide slot 421 has an end portion that is distant from the wire passing slit 44 in the horizontal direction (B), and that has a width measured in the wire routing direction (A) being greater than a width of the rest portion of the slide slot 421 measured in the wire routing direction (A) (as shown in FIG. 5), such that the positioning slider 5 may be inserted from the end portion of the slide slot 421 into the rest portion of the slide slot 421, or be removed from the slide slot 421 via the end portion of the slide slot 421. The width of the bottom slot 422 in the wire routing direction (A) remains constant in the horizontal direction (B).

The bottom frame portion 42 is further formed with a plurality of teeth grooves 423 that are spatially connected to the bottom slot 422 and that are arranged in the horizontal direction (B). The teeth grooves 423 are evenly distributed at opposite sides of the slide slot 421 that are opposite in the wire routing direction (A), where each of the teeth grooves 423 disposed at one side of the slide slot 421 is aligned with a respective one of the teeth grooves 423 disposed at another side of the slide slot 421.

The limiting arm portion 43 of the limiting member 4 is formed with an auxiliary slot 431 that is elongated in the horizontal direction (B) and that is disposed over and in spatial communication with the wire passing slit 44, and a plurality of counting grooves 432 that are spatially connected to the auxiliary slot 431 and that are arranged in the horizontal direction (B). The counting grooves 432 are evenly distributed at opposite sides of the auxiliary slot 431 that are opposite in the wire routing direction (A), where each of the counting grooves 432 disposed at one side of the auxiliary slot 431 is aligned with a respective one of the counting grooves 432 disposed at another side of the auxiliary slot 431.

Referring to FIGS. 4, 6 and 7, the positioning slider 5 includes two seat portions 51 that are disposed respectively in the auxiliary slot 431 and the bottom slot 422 and that are slidable relative to the auxiliary slot 431 and the bottom slot 422, a link portion 52 that is connected between the two seat portions 51 and that is slidably disposed in the slide slot 421, an abutting portion 53 that is connected to the link portion 52 and that is insertable into the wire passing slit 44 during sliding movement of the positioning slider 5 in the horizontal direction (B) relative to the limiting member 4, a teeth portion 54 that protrudes upward from one of the two seat portions 51 (i.e., the one disposed in the bottom slot 422) and that is removably engageable with the plurality of teeth grooves 423, and an end pin portion 55 that has opposite end segments protruding respectively from opposite sides of another one of the two seat portions 51 (i.e., the one disposed in the auxiliary slot 431) in the wire routing direction (A). The end segments of the end pin portion 55 are removably engageable with the plurality of counting grooves 432.

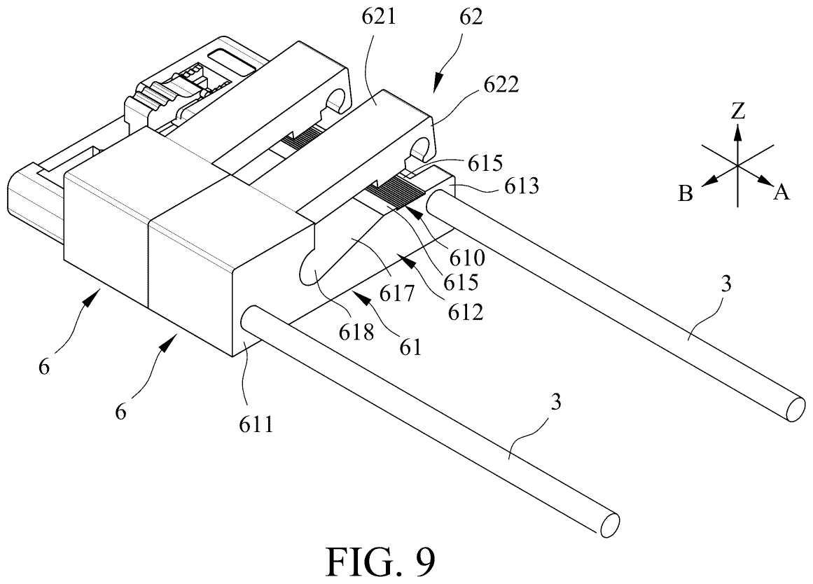

Referring to FIGS. 4, 8 and 9, the two combing members 6 are arranged in the wire routing direction (A) and are made of a flexible material. Each of the two combing members 6 includes a base 61 that is slidably disposed on the two guide pins 3, and a pressing part 62 that is disposed on the base 61 and that is movable relative to the base 61. The base 61 and the pressing part 62 of each of the two combing members 6 are integrally connected as one piece.

The base 61 of each of the combing members 6 has a base body portion 611, a base extending portion 612 that extends from the base body portion 611 in the horizontal direction (B), two connecting portions 613 that protrude from the base extending portion 612 in the horizontal direction (B), a plurality of first splitting protrusions 614 that protrude upward from a top end of the base extending portion 612 and that are arranged in the horizontal direction (B), and two blocking portions 615 that protrude upward from the top end of the base extending portion 612, that are spaced apart from each other in the horizontal direction (B), and that are disposed respectively at opposite sides of the plurality of first splitting protrusions 614. For each of the combing members 6, one of the two guide pins 3 extends through the base body portion 611 of the base 61, and another one of the guide pins 3 extends through the connecting portions 613 of the base 61. A height of each of the blocking portions 615 in the vertical direction (Z) measured from the top end of the base extending portion 612 is greater than a height of the first splitting protrusions 614 in the vertical direction (Z) measured from the top end of the base extending portion 612.

The base 61 of each of the combing members 6 is formed with a plurality of positioning grooves 610 that are arranged at intervals in the horizontal direction (B) for receiving the fiber optic wires (C). Specifically, each adjacent pair of the plurality of first splitting protrusions 614 cooperatively defines a respective one of the plurality of positioning grooves 610.

The pressing part 62 of each of the combing members 6 is operable to move toward the base 61 to engage with the fiber optic wires (C) received in the positioning grooves 610. The pressing part 62 of each of the combing members 6 has a pressing body portion 621 that is connected to the base body portion 611 of the base 61, and that is movable relative to the base extending portion 612 of the base 61, and a hook portion 622 that is connected to an end of the pressing body portion 621 opposite to the base body portion 611 of the base 61. For each of the combing members 6, the two connecting portions 613 and the hook portion 622 are arranged alternately in the wire routing direction (A). It should be noted that the numbers of the connecting portions 613 and the hook portion 622 are not limited to the present embodiment, and may be interchanged (i.e., one connecting portion 613 and two hook portions 622) according to actual needs.

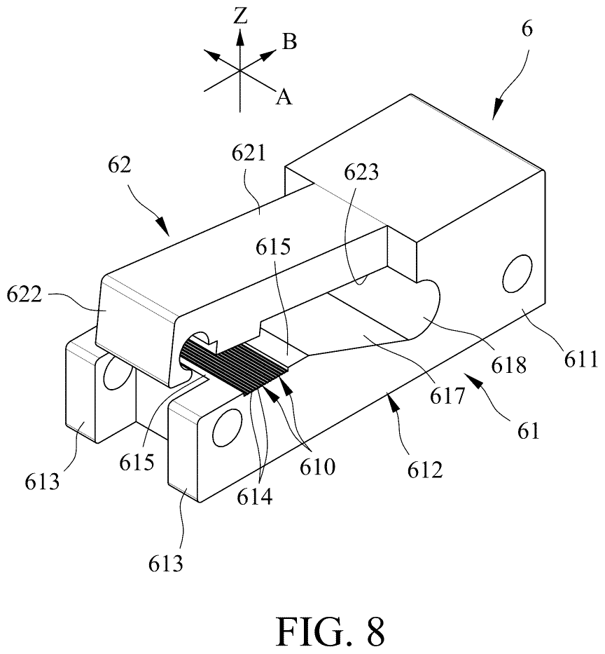

Referring to FIGS. 8, 9 and 10, for each of the combing members 6, the base extending portion 612 has an inclined surface 617 that extends from a top end of one of the two blocking portions 615 and that slopes downward in the horizontal direction (B). The base body portion 611 has a curved surface 618 that is curved and that is connected to the inclined surface 617 at one of opposite ends thereof. The pressing body portion 621 has a lower surface 623 that is connected to another one of the opposite ends of the curved surface 618 and that faces downwards.

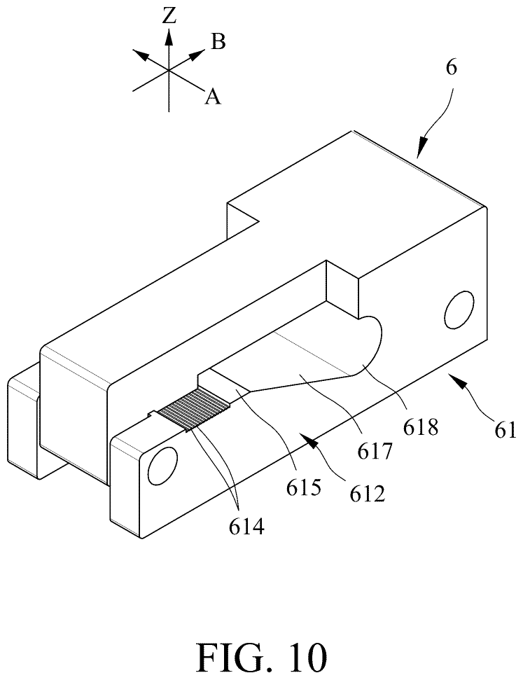

By virtue of the base 61 and the pressing part 62 of each of the combing members 6 being flexible and integrally connected as one piece and the configuration of the inclined surface 617, each of the combing members 6 is convertible from an open state (as shown in FIG. 8) to a closed state (as shown in FIG. 10) when the pressing part 62 is pressed by an external force. Specifically, when each combing member 6 is in the open state, the hook portion 622 of the pressing part 62 is disposed away from the connecting portions 613 of the base 61, and when each combing member 6 is in the closed state, the hook portion 622 of the pressing part 62 is proximate to the connecting portions 613 of the base 61 and the pressing part 62 is approximately parallel to the base 61. Moreover, when each combing member 6 is in the closed state, the hook portion 622 of the pressing part 62 engages the one of the guide pins 3 extending through the connecting portions 613 such that the pressing part 62 is temporary locked in position relative to the base 61. In addition, by virtue of the configuration of the curved surface 618, stress concentration in each combing member 6 is minimized during movement of the base 61, thereby enhancing the durability of its overall structure. In variations of the present embodiment, a segment connected between the pressing body portion 621 and the base body portion 611 may have a thinner configuration so as to facilitate operation of the pressing part 62.

Referring to FIGS. 4, 6 and 11, during operation of the present embodiment, the plurality of fiber optic wires (C) are first arranged side-by-side in the horizontal direction (B) and inserted in a specific order into the wire passing slit 44. Then, the positioning slider 5 is operated to slide in the horizontal direction (B) into the wire passing slit 44 with the link portion 52 of the positioning slider 5 moving along the slide slot 421 until the abutting portion 53 of the positioning slider 5 abuts against an outermost one of the fiber optic wires (C). At this point, the end segments of the end pin portion 55 are engaged with two corresponding ones of the counting grooves 432 that are disposed at opposite sides of the auxiliary slot 431, and the teeth portion 54 is engaged with a corresponding portion of the teeth grooves 423. It should be noted that since the height of the wire passing slit 44 in the vertical direction (Z) is predetermined to match the diameter of each of the fiber optic wires (C), once the fiber optic wires (C) are received in the wire passing slit 44, movement of the fiber optic wires (C) in the vertical direction (Z) is limited and the fiber optic wires (C) cannot overlap or crisscross one another, and thus the fiber optic wires (C) are maintained in the specific order. Furthermore, since configuration of the counting grooves 432 is designed in accordance with the diameter of the fiber optic wires (C), the number of the fiber optic wires (C) received in the wire passing slit 44 can be determined by identifying which two of the counting grooves 432 the end pin portion 55 is engaged with (the limiting arm portion 43 may be marked with identifiers). In addition, the engagement of the teeth portion 54 and the teeth grooves 423 not only produces a series of ratchet-like sensory feedback, but also secures the positioning slider 5 in position (unless an excessive force is applied), thereby limiting movement of the fiber optic wires (C) in the horizontal direction (B). At this point, the fiber optic wires (C) are only allowed to move in the wire routing direction (A). It should also be noted that during the aforementioned process, the combing members 6 are disposed near rear ends of the guide pins 3 that are opposite to the limiting member 4 in the wire routing direction (A).

Referring to FIGS. 4, 8 and 11, next, the combing members 6 are moved toward the limiting member 4 but maintained a certain distance, and the fiber optic wires (C) are received by the positioning grooves 610 between the blocking portions 615, with the blocking portions 615 providing a positioning effect that further limits the movement of the fiber optic wires (C) in the horizontal direction (B). It should be noted that in the previous process where the fiber optic wires (C) are inserted into the wire passing slit 44, it should be ensured that a certain portion of the fiber optic wires (C) should extend out of the wire passing slit 44 such that said portion of the fiber optic wires (C) can be subsequently placed on the base body portions 611 of the combing members 6. Then, the pressing parts 62 of the combing members 6 are moved simultaneously or separately toward the bases 61 until the hook portions 622 of the pressing parts 62 are engage with the corresponding one of the guide pins 3 (i.e., the combing members 6 are converted to the closed state), and the pressing body portions 621 of the pressing part 62 are engaged with the fiber optic wires (C) received in the positioning grooves 610, further limiting the movement of the fiber optic wires (C) in the vertical direction (Z) and keeping the fiber optic wires (C) in the positioning grooves 610. Afterward, the one of the combing members 6 disposed farther from the limiting member 4 is moved away from the limiting member 4 in the wire routing direction (A), until a distance between the two combing members 6 reaches a predetermined value (i.e., until a length of each of the fiber optic wires (C) measured between the two combing members 6 meets a desired value for making a ribbon fiber optic cable). It should be noted that during this process, each of the combing members 6 exerts a pulling force to the fiber optic wires (C), which prevents the fiber optic wires (C) from bending between the combing members 6.

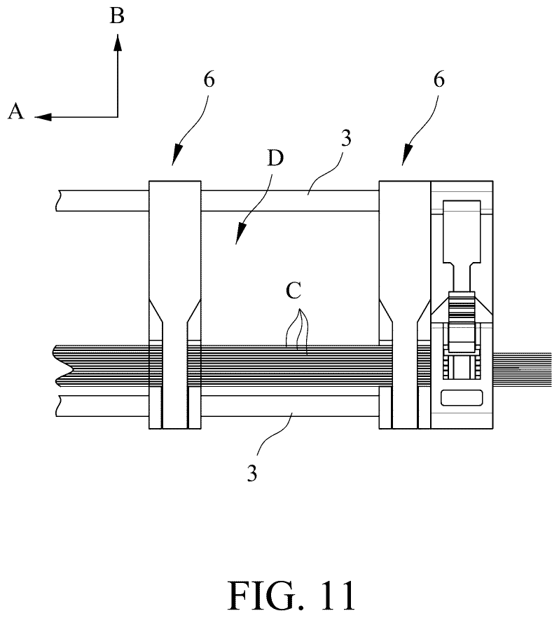

Referring to FIG. 11, finally, the two combing members 6 and the two guide pins 3 cooperatively define a gluing space (D) therebetween that is substantially rectangular, and most portions of the fiber optic wires (C) are exposed in the gluing space (D). At this point, an adhesive may be applied to the fiber optic wires (C) in the gluing space (D) to bond the fiber optic wires (C) together to form a ribbon fiber optic cable. Since the adhesive is applied in the gluing space (D), direct contact between the adhesive and the fiber optic alignment device can be prevented (e.g., a physical barrier may be placed on or underneath the device for catching the adhesive). Therefore, maintenance and cleaning are not required after each bonding process, and wear and tear of the fiber optic alignment device can be minimized.

It should be noted that in addition to the incorporation of the first splitting protrusions 614, the pressing part 62 of each of the combing members 6 further has a plurality of second splitting protrusions 624 that protrude downwards from the pressing body portion 621. In the present embodiment, the second splitting protrusions 624 is configured to be aligned respectively with the first splitting protrusions 614 in the vertical direction (Z) (not shown), so as to minimize bending movement of the pressing body portion 621 of the pressing part 62, and a shape of each of the second splitting protrusions 624 is configured as the same as that of each of the first splitting protrusions 614.

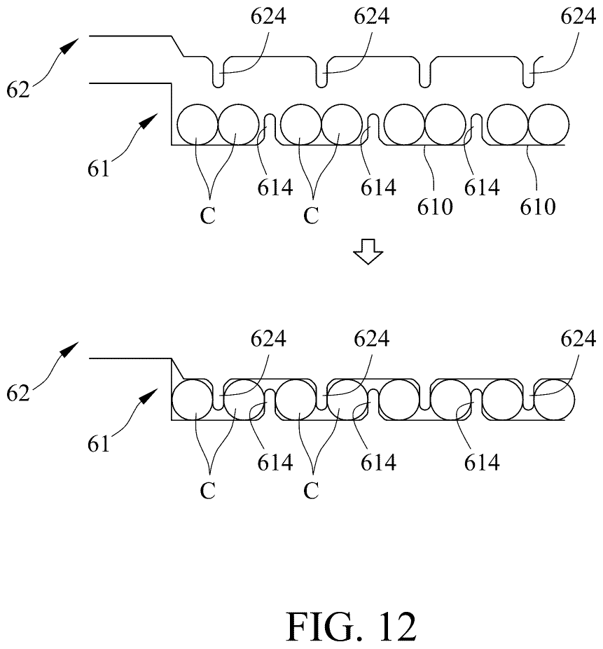

In addition, in variations of the present embodiment, the second splitting protrusions 624 and the first splitting protrusions 614 may be arranged substantially alternately in the horizontal direction (B), and a shape of each of the second splitting protrusions 624 may be configured to be different from that of each of the first splitting protrusions 614, so as to provide different alignment or positioning effects. Specifically, FIG. 12 illustrates the open and closed states of one of the combing members 6 in a variation of the present embodiment, where the second splitting protrusions 624 and the first splitting protrusions 614 are arranged substantially alternately in the horizontal direction (B). In this variation, when the fiber optic wires (C) are disposed on the base 61 and the combing member 6 is in the open state, the fiber optic wires (C) are divided by the first splitting protrusions 614 into pairs, and each pair of the fiber optic wires (C) is received in a respective one of the positioning grooves 610. When the pressing part 62 is pressed down and the combing member 6 is converted to the closed state, each of the second splitting protrusions 624 moves into a respective one of the positioning grooves 610 and separates a respective pair of the fiber optic wires (C). Such configuration allows for progressive separation of the fiber optic wires (C) and minimizes displacement of the fiber optic wires (C) at each step, thereby preventing potential damage to the fiber optic wires (C). Furthermore, since the first splitting protrusions 614 and the second splitting protrusions 624 are arranged at wider intervals compared to the prior art (i.e., the space between each adjacent pair of the first splitting protrusions 614 or the second splitting protrusions 624 is configured to accommodate two fiber optic wires while each track groove of the prior art is configured to accommodate only one fiber optic wire), the present embodiment is configured with less protrusions and grooves compared to the prior art, thus requiring a less complex mold-making process.

In summary, by virtue of the incorporation of the limiting member 4 that maintains the order of the fiber optic wires (C), and the incorporation of the combing members 6 that ensures proper spacing and alignment of the fiber optic wires (C), the fiber optic alignment device according to the present disclosure is able to prevent the fiber optic wires (C) from bending and misalignment during the bonding process, thereby ensuring a stable yield of the ribbon fiber optic cable. Thus, the objective of the present disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fiber optic alignment device adapted for positioning a plurality of fiber optic wires, comprising:
two guide pins extending in a wire routing direction and being spaced apart from each other in a horizontal direction perpendicular to the wire routing direction;
a limiting member fixedly disposed on said two guide pins and formed with a wire passing slit that extends therethrough in the wire routing direction, a height of said wire passing slit in a vertical direction which is perpendicular to the wire routing direction and the horizontal directional being adapted to match a diameter of each of the plurality of fiber optic wires such that said wire passing slit is adapted to receive the plurality of fiber optic wires that are arranged side-by-side in the horizontal direction; and
two combing members, each of said two combing members including a base that is slidably disposed on said two guide pins, and a pressing part that is disposed on said base and that is movable relative to said base, said base being formed with a plurality of positioning grooves that are arranged at intervals in the horizontal direction and that are adapted to receive the plurality of fiber optic wires, said pressing part being operable to move toward said base and to engage with the plurality of fiber optic wires received in said plurality of positioning grooves.

2. The fiber optic alignment device as claimed in claim 1, wherein said two combing members are flexible, said base and said pressing part of each of said two combing members being integrally connected as one piece.

3. The fiber optic alignment device as claimed in claim 1, wherein:
said base of each of said two combing members has
a base body portion, one of said two guide pins extending through said base body portion,
a base extending portion that extends from said base body portion in the horizontal direction, and
at least one connecting portion that protrudes from said base extending portion in the horizontal direction, another one of said two guide pins extending through said at least one connecting portion;
said pressing part of each of said two combing members has
a pressing body portion that is connected to said base body portion of said combing member, and that is movable relative to said base extending portion of said combing member, and
at least one hook portion that is connected to an end of said pressing body portion opposite to said base body portion of said combing member;
for each of said two combing members, said at least one connecting portion and said at least one hook portion are arranged alternately in the wire routing direction; and
for each of said two combing members, when said pressing part is moved toward said base to engage with the plurality of fiber optic wires, said at least one hook portion is engaged with said another one of said two guide pins.

4. The fiber optic alignment device as claimed in claim 1, wherein:
said base of each of said two combing members further has
a plurality of first splitting protrusions that protrude upward from a top end of said base extending portion and that are arranged in the horizontal direction, and
two blocking portions that protrude upward from said top end of said base extending portion, that are spaced apart from each other in the horizontal direction, and that are disposed respectively at opposite sides of said plurality of first splitting protrusions;
a height of each of said two blocking portions in the vertical direction measured from said top end of said base extending portion is greater than a height of said plurality of first splitting protrusions in the vertical direction measured from said top end of said base extending portion; and
each adjacent pair of said plurality of first splitting protrusions cooperatively defines a respective one of said plurality of positioning grooves.

5. The fiber optic alignment device as claimed in claim 4, wherein, for each of said two combing members:
said base extending portion has an inclined surface that extends from a top end of one of said two blocking portions and that slopes downward in the horizontal direction;
said base body portion has a curved surface that is curved and that is connected to said inclined surface at one of opposite ends thereof; and
said pressing body portion has a lower surface that is connected to another one of said opposite ends of said curved surface and that faces downwards.

6. The fiber optic alignment device as claimed in claim 1, wherein said limiting member includes two installing portions that are sleeved respectively on said two guide pins, a bottom frame portion that is connected between said installing portions in the horizontal direction, and a limiting arm portion that extends from one of said two installing portions, and that cooperates with said bottom frame portion to define said wire passing slit.

7. The fiber optic alignment device as claimed in claim 1, further comprising a positioning slider that is disposed on said limiting member, and that is slidable in the horizontal direction relative to said limiting member into said wire passing slit for limiting movement of the plurality of fiber optic wires in the horizontal direction.

8. The fiber optic alignment device as claimed in claim 6, further comprising a positioning slider that is disposed on said limiting member and that is slidable in the horizontal direction relative to said limiting member, said bottom frame portion of said limiting member being formed with a slide slot that is elongated in the horizontal direction and that is disposed under and in spatial communication with said wire passing slit, and a bottom slot that is disposed under and in spatial communication with said slide slot, a width of said bottom slot measured in the wire routing direction being greater than a width of said slide slot measured in the wire routing direction, said limiting arm portion of said limiting member being formed with an auxiliary slot that is elongated in the horizontal direction and that is disposed over and in spatial communication with said wire passing slit, said positioning slider including two seat portions that are disposed respectively in said auxiliary slot and said bottom slot and that are slidable relative to said auxiliary slot and said bottom slot, a link portion that is connected between said two seat portions and that is slidably disposed in said slide slot, and an abutting portion that is connected to said link portion and that is insertable into said wire passing slit during sliding movement of said positioning slider in the horizontal direction relative to said limiting member.

9. The fiber optic alignment device as claimed in claim 8, wherein said bottom frame portion of said limiting member is further formed with a plurality of teeth grooves that are spatially connected to said bottom slot and that are arranged in the horizontal direction, said limiting arm portion of said limiting member being formed with a plurality of counting grooves that are spatially connected to said auxiliary slot and that are arranged in the horizontal direction, said positioning slider further including a teeth portion that protrudes upward from one of said two seat portions and that is removably engageable with said plurality of teeth grooves, and an end pin portion that has opposite end segments protruding respectively from opposite sides of another one of said two seat portions in the wire routing direction, said end segments of said end pin portion being removably engageable with said plurality of counting grooves.

10. The fiber optic alignment device as claimed in claim 4, wherein said pressing part of each of said combing members further has a plurality of second splitting protrusions that protrude downwards from said pressing body portion.

11. The fiber optic alignment device as claimed in claim 10, wherein said plurality of first splitting protrusions are respectively aligned with said plurality of second splitting protrusions in the vertical direction.

12. The fiber optic alignment device as claimed in claim 10, wherein said plurality of first splitting protrusions and said plurality of second splitting protrusions are arranged substantially alternately in the horizontal direction.

13. The fiber optic alignment device as claimed in claim 10, wherein a shape of each of said plurality of second splitting protrusions is the same as that of each of said plurality of first splitting protrusions.

14. The fiber optic alignment device as claimed in claim 10, wherein a shape of each of said plurality of second splitting protrusions is different from that of each of said plurality of first splitting protrusions.
